(19) United States
(12) Patent Application Publication
(10) Pub. No.: US 2003/0180547 A1
(43) Pub. Date: Sep. 25, 2003

(54) Solar control coating

(76) Inventors: Harry Buhay, Allison Park, PA (US); James J. Finley, Pittsburgh, PA (US); James P. Thiel, Pittsburgh, PA (US)

Correspondence Address: PPG Industries, Inc., Law - Intellectual Property - 39, One PPG Place, Pittsburgh, PA, 15272, US

(21) Appl. No.: 10/364,089

(22) Filed: Feb. 11, 2003

Related U.S. Application Data
(60) Provisional application No. 60/355,912, filed on Feb. 11, 2002.

(51) Int. Cl. B05D 5/06; B05D 1/36; B32B 17/06

(52) U.S. Cl. 428/434; 427/402; 427/162; 428/432

(57) ABSTRACT

A coating is provided having a first anti-reflective layer; a first infrared reflective film deposited over the first anti-reflective layer; a second anti-reflective layer deposited over the first infrared reflective film; a second infrared reflective film deposited over the second anti-reflective layer; a third anti-reflective layer deposited over the second infrared reflective film; and a third infrared reflective film deposited over the third anti-reflective layer.

### CROSS-REFERENCE TO RELATED APPLICATION

This application claims the benefits of U.S. Provisional Application Serial No. 60/355,912 filed Feb. 11, 2002, which is herein incorporated by reference in its entirety.

### BACKGROUND OF THE INVENTION

1. Field of the Invention

This invention relates generally to multi-layered coatings and, in one embodiment, to a multi-layered solar control coating having improvements in areas such as reflectance, heat stability, mechanical durability, and chemical durability characteristics.

2. Description of the Currently Available Technology

The use of high transmittance, low emissivity coatings on glass panels for buildings, vehicles, and other structures is well known for controlling the amount of solar radiation passing through the panels. Low emissivity coatings allow short wavelength energy, e.g., visible or ultraviolet energy, to pass through the coating but reflect long wavelength energy, e.g., infrared energy. Such coatings are attractive for architectural and vehicle use since they reduce the costs of heating and/or cooling and, hence, conserve energy.

These known coatings typically include an infrared reflecting metallic layer sandwiched between two dielectric layers of metal oxides to reduce the visible reflectance. For example, U.S. Pat. No. 4,898,790 discloses a multi-layered, high transmittance, low emissivity coating having a metallic silver film sandwiched between two zinc stannate films. U.S. Pat. No. 4,898,789 discloses a multi-layered, high transmittance, low emissivity film having two infrared reflective metal films alternatingly combined with three metal oxide anti-reflective films. As a general rule, the thicker the infrared reflective film, the lower will be the emissivity of the coating. Similarly, increasing the number of infrared reflective films also lowers the coating emissivity. However, while increasing the thickness and/or number of infrared reflecting films decreases emissivity, it also affects the other characteristics of the coating, such as color, angular color shift, heat stability, chemical durability, mechanical durability, and visible reflectance. For example, increasing the number and/or thickness of the infrared reflective films typically decreases visible light transmission. Thus, it is not possible simply to add additional infrared reflecting films and dielectric films to a coating stack without significantly changing the transmission characteristics and solar performance properties of the coated article. This is particularly true in coated glass destined for use in the automotive field where the transmittance is controlled by government regulations. Also it has been found by the inventors that coating stacks with double infrared reflecting films each sandwiched between dielectric films are generally softer than comparable single infrared reflecting film stacks. The latter are coating stacks with one film or layer of infrared reflecting material sandwiched between dielectric films where any other films that are present would also be present in the double infrared reflecting film coating stack. Additionally, many low emissivity coatings break down or deteriorate upon heating to temperatures in the range of conventional glass processing temperatures, such as for bending, annealing, tempering, or laminating.

While these known coatings are adequate for conventional automotive use, it would be advantageous to provide a low emissivity or solar control coating that improves upon at least some of the characteristics of the known coatings. For example, it would be advantageous to provide a coating that has lower visible light reflectance than known coatings. It would also be advantageous to provide a low emissivity or solar control coating having reduced angular color shift compared to known coatings. Moreover, it would be advantageous to provide a solar control coating that could be applied to a substrate and subsequently heat treated at elevated temperatures to bend or shape the substrate without adversely affecting the solar control properties of the coating; and where heating improves the coating properties. It would further be advantageous to provide a coating having improved chemical durability and/or mechanical durability while maintaining a desirable level of solar control activity. It would also be advantageous to provide a coating having improved, e.g., higher, visible light transmittance while maintaining or surpassing the solar control characteristics of known solar control coatings.

### SUMMARY OF THE INVENTION

A coating of the invention comprises three spaced infrared reflective films, one such non-exclusive example is silver containing films, with at least one anti-reflective layer located between adjacent infrared reflecting films. The coating can have a high visible light transmittance (Lta), e.g., greater than or equal to 60%, such as greater than or equal to 70%, e.g., greater than or equal to 72%, e.g., greater than or equal to 75%. Additionally, the coating can have a neutral color. In one embodiment, the coating has an a* and b* less than or equal to ±|3|, such as less than or equal to ±|2|, and an L* less than or equal to 50, e.g., less than or equal to 44, such as less than or equal to 40, e.g., less than or equal to 36, e.g., less than or equal to 35, such as less than or equal to 33. Additionally the coating can have a total solar energy reflectance (TSER) over the range of 300 nanometers (nm) to 2150 nm of 20% to 50% (using a trapezoidal integration system). Moreover, the coating can have a low visible light reflectance, such as less than or equal to 5% above the visible light reflectance of the the substrate upon which it is deposited, e.g., less than or equal to 2%, e.g., less than or equal to 1%. In one embodiment, the infrared reflectance films can each have a sheet resistance in the range of 4.5 to 10 Ω/□. In another embodiment the triple coating on glass can result in a sheet resistance for the coating on glass in the range of 1.5 to 3.5 Ω/□. The thickness of each infrared reflective film can be the same or different in the coating stack. Generally the total amount of the metal for all three of the infrared reflecting films is greater than the amount of metal for all t of the infrared reflecting films in commercially available double silver infrared reflecting coatings which give a luminous transmission of greater than at least 65 and more appropriately 70 percent or greater.

In another embodiment, the coating comprises a first anti-reflective layer; a first infrared reflective film deposited over the first anti-reflective layer; a second anti-reflective layer deposited over the first infrared reflective film; a second infrared reflective film deposited over the second anti-reflective layer; a third anti-reflective layer deposited over the second infrared reflective film; and a third infrared reflective film deposited over the third anti-reflective layer.

Another coating of the invention comprises a first anti-reflective layer, e.g., comprising a metal oxide film, e.g., a zinc oxide film, deposited over a metal alloy oxide film, e.g., a zinc stannate film; a first infrared reflective metallic film comprising silver deposited over the first anti-reflective layer; a second anti-reflective layer deposited over the first infrared reflective film and comprising a first metal oxide film, e.g., a zinc oxide film, a metal alloy oxide film, e.g., a zinc stannate film, deposited over the first zinc oxide film, and a second metal oxide film, e.g., another zinc oxide film, deposited over the zinc stannate film; a second infrared reflective metallic film comprising silver deposited over the second anti-reflective layer; a third anti-reflective layer deposited over the second infrared reflective metallic film and comprising a first metal oxide film, e.g., a zinc oxide film, a metal alloy oxide film, e.g., a zinc stannate film, deposited over the first zinc oxide film, and a second metal oxide film, e.g., a zinc oxide film, deposited over the zinc stannate film; and a third infrared reflective metallic film comprising silver deposited over the third anti-reflective layer.

A method of coating a substrate in accordance with the invention comprises the steps of depositing a first anti-reflective layer over at least a portion of the substrate; depositing a first infrared reflective film over the first anti-reflective layer; depositing a second anti-reflective layer over the first infrared reflective film; depositing a second infrared reflective film over the second anti-reflective layer; depositing a third anti-reflective layer over the second infrared reflective film; and depositing a third infrared reflective film over the third anti-reflective layer.

A coated article of the invention comprises a substrate with a first anti-reflective layer deposited over at least a portion of the substrate; a first infrared reflective film deposited over the first anti-reflective layer; a second anti-reflective layer deposited over the first infrared reflective film; a second infrared reflective film deposited over the second anti-reflective layer; a third anti-reflective layer deposited over the second infrared reflective film; and a third infrared reflective film deposited over the third anti-reflective layer.

### BRIEF DESCRIPTION OF THE DRAWINGS

FIG. 1 is a side view (not to scale) of a coated article having a coating incorporating features of the invention; and

FIG. 2 is a side view (not to scale) of a laminated article incorporating features of the invention.

### DESCRIPTION OF THE PREFERRED EMBODIMENTS

As used herein, spatial or directional terms, such as “inner”, “outer”, “left”, “right”, “up”, “down”, “horizontal”, “vertical”, and the like, relate to the invention as it is shown in the drawing figures. However, it is to be understood that the invention can assume various alternative orientations and, accordingly, such terms are not to be considered as limiting. Further, all numbers expressing dimensions, physical characteristics, and so forth, used in the specification and claims are to be understood as being modified in all instances by the term “about”. Accordingly, unless indicated to the contrary, the numerical values set forth in the following specification and claims can vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 5.5 to 10. Also, as used herein, the terms “deposited over”, “applied over”, or “provided over” mean deposited, applied, or provided on but not necessarily in contact with the surface. For example, a material “deposited over” a substrate does not preclude the presence of one or more other materials of the same or different composition located between the deposited material and the substrate. Additionally, any reference referred to as being “incorporated herein” is to be understood as being incorporated in its entirety.

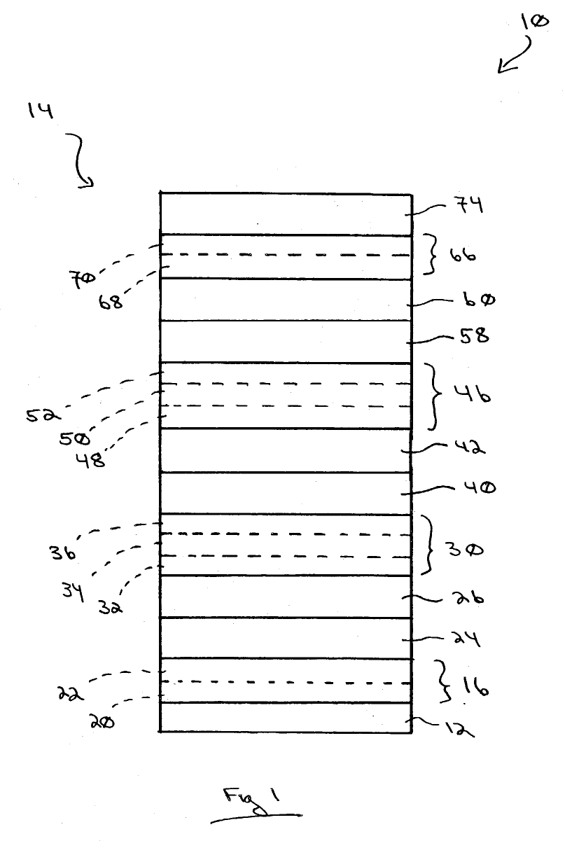

FIG. 1 illustrates a coated article 10 having a substrate 12 with a multi-layered coating 14 of the invention deposited over at least a portion of the substrate 12, e.g., over at least a portion of a major surface of the substrate 12.

In the broad practice of the invention, the substrate 12 can be of any desired material having any desired optical characteristics. For example, the substrate 12 can be transparent to visible light. By “transparent” is meant having a transmittance through the substrate 12 of greater than 0% up to 100% By “visible light” is meant electromagnetic energy in the range of 390 nm to 800 nm. Alternatively, the substrate 12 can be translucent or opaque. By “translucent” is meant allowing electromagnetic energy (e.g., visible light) to pass through but diffusing it such that objects on the other side are not clearly visible. By “opaque” is meant having a visible light transmittance of 0%. Suitable transparent materials include plastic (e.g., polymethylmethacrylate, polycarbonate, polyurethane, polyethyleneterephthalate (PET), or copolymers of any monomers for preparing these, or mixtures thereof), Mylar sheet or film, ceramic, or glass. The glass can be of any type, such as conventional float glass or flat glass, and can be of any composition having any optical properties, e.g., any value of visible transmission, ultraviolet transmission, infrared transmission, and/or total solar energy transmission. By “float glass” is meant glass formed by a conventional float process in which molten glass is deposited onto a molten metal bath and controllably cooled to form a float glass ribbon. The ribbon is then cut and/or shaped and/or heat treated as desired. Examples of float glass processes are disclosed in U.S. Pat. Nos. 4,466,562 and 4,671,155. The glass can be, for example, conventional soda-lime-silicate glass, borosilicate glass, or leaded glass. The glass can be “clear glass”, i.e., non-tinted or non-colored glass. Alternatively, the glass can be tinted or otherwise colored glass. The glass can be untempered, heat treated, or heat strengthened glass. As used herein, the term “heat strengthened” means annealed, tempered, or at least partially tempered. Although not limiting to the invention, examples of glass suitable for the substrate 12 are described in U.S. Pat. Nos. 4,746,347; 4,792,536; 5,240,886; 5,385,872; and 5,393,593, which are herein incorporated by reference. The substrate 12 can be of any desired dimensions, e.g., length, width, shape, or thickness. For conventional automotive transparencies, the substrate 12 can be up to 10 mm thick, e.g., 1 mm to 10 mm thick, e.g., less than 10 mm thick, e.g., 1 mm to 5 mm thick, e.g., 1.5 mm to 2.5 mm, e.g., 1.6 mm to 2.3 mm.

As shown in FIG. 1, the coating 14 is a multi-layered coating or coating stack. As used herein, the terms “coating” or “coating stack” mean having one or more coating layers. A “layer” can include one or more coating films. As used herein, the term “film” refers to a coating region of a desired or selected coating composition. Typically, the coating composition within a coating film is of a substantially uniform composition. The coating 14 can be a solar control coating, such as but not limited to a low emissivity coating. As used herein, the term “solar control coating” refers to a coating which affects the solar properties of the coated article, such as but not limited to shading coefficient and/or emissivity and/or the amount of solar radiation reflected by and/or absorbed by and/or transmitted through the coated article, e.g., infrared or ultraviolet absorption or reflection. The solar control coating can block, absorb, or filter selected portions of the solar spectrum, such as but not limited to the visible spectrum.

The coating 14 of the invention can be deposited over the substrate 12 by any conventional method, such as but not limited to spray pyrolysis, chemical vapor deposition (CVD), sol-gel, electron beam evaporation, or vacuum sputtering such as magnetron sputter vapor deposition (MSVD). In one embodiment, the coating 14 is deposited by MSVD. Examples of MSVD coating devices and methods will be well understood by one of ordinary skill in the art and are described, for example, in U.S. Pat. Nos. 4,379,040; 4,861,669; 4,898,789; 4,898,790; 4,900,633; 4,920,006; 4,938,857; 5,328,768; and 5,492,750. In the MSVD method, an oxide of a metal or metal alloy can be deposited by sputtering a metal or metal alloy containing cathode in an oxygen containing atmosphere to deposit a metal oxide or metal alloy oxide film on the surface of the substrate.

The coating 14 includes a base layer or first anti-reflective layer 16 deposited over at least a portion of a major surface of the substrate 12. The first anti-reflective layer 16 can comprise one or more films of dielectric materials or anti-reflective materials, such as metal oxides, oxides of metal alloys, nitrides, oxynitrides, or mixtures thereof. The first anti-reflective layer 16 can be transparent or substantially transparent. Examples of suitable metal oxides for the first anti-reflective layer 16 include oxides of titanium, hafnium, zirconium, niobium, zinc, bismuth, lead, indium, tin, and mixtures thereof. These metal oxides may have small amounts of other materials, such as manganese in bismuth oxide, indium in tin oxide, etc. Additionally, oxides of metal alloys or metal mixtures, such as oxides containing zinc and tin a non-exclusive example “e.g.” of which is (zinc stannate), oxides of indium-tin alloys, silicon nitrides, silicon aluminum nitrides, or aluminum nitrides, can be used. Further, doped metal oxides, such as antimony or indium doped tin oxides or nickel or boron doped silicon oxides can be used. The first anti-reflective layer 16 can be a substantially single phase film, such as a metal alloy oxide film, e.g., zinc stannate, or may be a mixture of phases composed of zinc and tin oxides or may be composed of a plurality of metal oxide films, such as those disclosed in U.S. Pat. Nos. 5,821,001; 4,898,789; and 4,898,790, which are herein incorporated by reference in their entirety.

In the illustrated embodiment, the first anti-reflective layer 16 comprises a multi-film structure having a first metal alloy oxide film 20 deposited over at least a portion of the major surface of the substrate 12 and a second metal oxide film 22 deposited over the first metal alloy oxide film 20. In one embodiment, the first anti-reflective layer 16 can have a total thickness of less than or equal to 500 Å, e.g., less than or equal to 300 Å, e.g., less than or equal to 280 Å. For example, the metal alloy oxide containing film 20 can have a thickness in the range of 100 Å to 500 Å, such as 150 Å to 400 Å, e.g., 200 Å to 250 Å. The metal oxide film 22 can have a thickness in the range of 50 Å to 200 Å, such as 75 Å to 150 Å, e.g., 100 Å. In one embodiment, the metal mixture or alloy oxide containing film can have preferably a majority of a zinc/tin alloy oxide. The zinc/tin alloy oxide can be that obtained from magnetron sputtering vacuum deposition from a cathode of zinc and tin that can comprise zinc and tin in proportions of 10 wt. % to 90 wt. % zinc and 90 wt. % to 10 wt. % tin. One suitable metal alloy oxide which can be present in the film for use in the invention is zinc stannate. By “zinc stannate” is meant a composition of ZnₓSn_{1-X}O_{2-X} (Formula 1) where x varies in the range of 0 to 1. For instance number x can be greater than 0 and can be any fraction or decimal between greater than 0 to the number 1. For example where x=⅔ Formula 1 is Zn_{2/3}Sn_{1/3}O_{4/3} which is more commonly described as “Zn₂SnO₄”. A zinc stannate containing film has one or more of the forms of Formula 1 in a predominant amount in the film. The metal oxide film can be a zinc containing film, such as zinc oxide. The zinc oxide film can include other materials to improve the sputtering characteristics of the associated cathode, e.g., the zinc oxide can contain 0 to 20 wt. % tin, e.g., 0 to 15 wt. % tin, e.g., 0 to 10 wt. % tin.

A first infrared (IR) reflective film 24 can be deposited over the first anti-reflective layer 16. The first IR reflective film 24 can be an IR reflective metal, such as but not limited to gold, copper, silver, or mixtures, alloys, or combinations thereof. The first IR reflective film 24 can have a thickness in the range of 25 Å to 300 Å, e.g., 50 Å to 300 Å, e.g., 50 Å to 150 Å, such as 70 to 110 Å like 75 Å to 100 Å, e.g., 80 Å. In one embodiment of the invention, the first infrared reflective film 24 comprises silver.

A first primer film 26 can be deposited over the first IR reflective film 24. The first primer film 26 can be an oxygen capturing material, such as titanium, that can be sacrificial during the deposition process to prevent degradation of the first IR reflective film 24 during a sputtering process. The oxygen capturing material can be chosen to oxidize before the material of the IR reflectance film. In one embodiment, the first primer film 26 can have a thickness in the range of 5 Å to 50 Å, e.g., 10 Å to 40 Å, e.g., 12 Å to 20 Å.

A second anti-reflective layer 30 can be deposited over the first primer film 26. The second anti-reflective layer 30 can comprise one or more metal oxide or metal alloy oxide containing films, such as those described above with respect to the first anti-reflective layer 16. In the illustrated embodiment, the second anti-reflective layer 30 has a first metal oxide film 32, e.g., zinc oxide, deposited over the first primer film 26. A second metal alloy oxide film 34, e.g., a zinc stannate film, is deposited over the first zinc oxide film 32. A third metal oxide film 36, e.g., another zinc oxide film, is deposited over the zinc stannate film 34 to form the multi-film layer 30. Each metal oxide film 32, 36 of the second anti-reflective layer 30 can have a thickness in the range of about 50 Å to 200 Å, e.g., 75 Å to 150 Å, e.g., 100 Å. The metal alloy oxide film 34 can have a thickness in the range of 100 Å to 500 Å, e.g., 200 Å to 500 Å, e.g., 300 Å to 500 Å, e.g., 400 Å.

A second IR reflective film 40 can be deposited over the second anti-reflective layer 30. The second IR reflective film 40 can include any of the IR reflective materials as described above with respect to the first IR reflective film 24. The second IR reflective film 40 can have a thickness in the range of 25 Å to 150 Å e.g., 50 Å to 100 Å e.g., 80 Å to 90 Å. In the illustrated embodiment, the second IR reflective film 40 includes silver In another embodiment this second infrared reflecting film can be thicker than each of the first and third infrared reflecting films.

A second primer film 42 can be deposited over the second IR reflective film 40. The second primer film 42 can be any of the materials described above with respect to the first primer film 26. The second primer film can have a thickness in the range of about 5 Å to 50 Å e.g., 10 Å to 25 Å e.g., 12 Å to 20 Å. In the illustrated embodiment, the second primer film 42 includes titanium.

A third anti-reflective layer 46 can be deposited over the second primer film 42. The third anti-reflective layer 46 can also include one or more metal oxide or metal alloy oxide containing films such as discussed above with respect to the first and second anti-reflective layers 16, 30. In the illustrated embodiment, the third anti-reflective layer 46 is a multi-film layer similar to the second anti-reflective layer 30. For example, the third anti-reflective layer 46 can include a first metal oxide film 48, e.g., a zinc oxide film, a second metal alloy oxide containing film 50, e.g., a zinc stannate film, deposited over the zinc oxide film 48, and a third metal oxide film 52, e.g., another zinc oxide film, deposited over the zinc stannate containing film 50. The metal oxide films can have thicknesses in the range of 50 Å to 200 Å such as 75 Å to 150 Å e.g., 100 Å. The metal alloy oxide film can have a thickness in the range of 100 Å to 500 Å, e.g., 200 Å to 500 Å e.g., 300 Å to 500 Å e.g., 400 Å.

Unlike conventional solar control coatings, the coating stack of the invention further includes a third IR reflective film 58 deposited over the third anti-reflective layer 46. The third IR reflective film 58 can be of any of the materials discussed above with respect to the first and second IR reflective films 24, 40. The third IR reflective film 58 can have a thickness in the range of 50 Å to 100 Å e.g., 70 Å to 90 Å e.g., 75 Å to 85 Å. In the illustrated embodiment, the third IR reflective film 58 includes silver. When the first, second, and third infrared reflective film has or contains silver the total amount of silver for the coating can range in the amount of 29 to 44 micrograms per centimeter² (ugm/cm²) and in one embodiment around 36.5 ugm/cm².

A third primer film 60 can be deposited over the third infrared reflective film 58. In one embodiment, the third primer film 60 can be of any of the primer materials described above. The third primer film 60 can have a thickness in the range of 5 Å to 50 Å e.g., 10 Å to 25 Å e.g., 12 Å to 20 Å. In the illustrated embodiment, the third primer film 60 is titanium.

A fourth anti-reflective layer 66 can be deposited over the third primer film 60. The fourth anti-reflective layer 66 can be comprised of one or more metal oxide or metal alloy oxide containing films such as those discussed above with respect to the first, second, or third anti-reflective layers 16, 30, 46. In one embodiment, the fourth anti-reflective layer 66 is a multi-film layer having a first metal oxide film 68, e.g., a zinc oxide film, deposited over the third primer film 60 and a second metal alloy oxide film 70, e.g., a zinc stannate film, deposited over the zinc oxide film 68. The metal oxide film can have a thickness in the range of 25 Å to 200 Å such as 50 Å to 150 Å such as 100 Å. The metal alloy oxide film 70 can have a thickness in the range of 25 Å to 500 Å e.g., 50 Å to 250 Å e.g., 100 Å to 150 Å.

A protective overcoat 74 can be deposited over the fourth anti-reflective layer 66 to assist in providing protection against mechanical and chemical attack In one embodiment, the protective overcoat 74 can be a metal oxide, such as titanium dioxide or zirconium oxide, having a thickness in the range of about 25 Å to 100 Å e.g., 40 Å to 60 Å e.g., 50 Å. In another embodiment, the protective overcoat 74 can be titanium metal having a thickness in the range of 10 Å to 100 Å e.g., 25 Å to 75 Å e.g., 50 Å. In a still further embodiment, an outer coating (not shown), such as an oxide, nitride, or oxynitride of silicon, or mixtures thereof, can be deposited over the protective overcoat 74 or in lieu thereof. For example, the outer coating can include dopants, such as oxides, nitrides, or oxynitrides of silicon doped with one or more of aluminum or boron. Examples of some suitable protective coatings are disclosed in U.S. Pat. Nos. 4,716,086; 4,786,563; 4,861,669; 4,938,857; and 4,920,006; Canadian Application No. CA 2,156,571, and U.S. Patent Application No. 60/242,543 and Ser. No. 10/007,382, which patents and applications are herein incorporated by reference.

As will be appreciated by one skilled in the art, the coating 14 of the invention can be utilized in both laminated and non-laminated, e.g., single ply, articles. FIG. 1 shows a monolithic article having a coating 14 of the invention. By “monolithic” is meant having a single structural substrate 12 or primary ply, e.g., a glass ply. By “primary ply” is meant a primary support or structural member. The article can be a vehicle (e.g., automotive or aircraft) transparency. As used herein, the term “automotive transparency” refers to an automotive windshield, sidelight, back light, moon roof, sunroof, and the like. The “transparency” can have a visible light transmission (Lta) of any desired amount, e.g., greater than 0% to 100%. For vision areas, the visible light transmission can be greater than or equal to 50%, e.g., greater than or equal to 60%, e.g., greater than or equal to 70%, e.g., greater than or equal to 72%, e.g., greater than or equal to 75%. Alternatively, the article can be a conventional architectural transparency, such as but not limited to one or more panes of an insulating glass unit, a residential or commercial single pane or laminated window, a skylight, etc.

While the protective overcoat 74 can be of any thickness, for monolithic articles the protective overcoat 74 can have a thickness of 1 micron or more to reduce or prevent color variation in the appearance of the article. The protective overcoat 74 can have a thickness of less than or equal to 5 microns, e.g., about 1 to about 3 microns. For automotive use, the protective overcoat 74 can be sufficiently thick to pass the conventional ANSI/SAE 26.1-1996 test with less than 2% gloss loss over 1000 revolutions in order to be used as an automotive transparency. Further, the protective overcoat 74 need not be of uniform thickness but may have high and low spots or areas, such as when the refractive index of the coating is the same or close to the reflective index of the material to which it is laminated.

The protective overcoat 74 can be of any desired material. For instance the protective overcoat 74 can include one or more metal oxide materials, such as but not limited to, aluminum oxide, silicon oxide, or mixtures thereof as one or more films or layers such as one or more of the aforelisted metal oxides can be in one film and another film above the former film and can have another of the listed metal oxides or different mixture of them. For example, the protective overcoat 74 can be in the range of 35 weight percent (wt. %) to 100 wt. % alumina and 65 wt. % to 0 wt. % silica, e.g., 70 wt. % to 90 wt. % alumina and 10 wt. % to 30 wt. % silica, e.g., 75 wt. % to 85 wt. % alumina and 15 wt. % to 25 wt. % of silica, e.g., 88 wt. % alumina and 12 wt. % silica, e.g., 65 wt. % to 75 wt. % alumina and 25 wt. % to 35 wt. % silica, e.g., 70 wt. % alumina and 30 wt. % silica. Other materials, such as aluminum, chromium, hafnium, yttrium, nickel, boron, phosphorous, titanium, zirconium, and oxides thereof, can be present to affect the refractive index of the protective overcoat 74. Such a protective overcoat 74 can be a multilayered film of one or more films of one or more of the aforelisted metal oxides under a titanium or titania protective film. The protective overcoat 74 can have an index of refraction that is about the same as that of the substrate 12. For example, if the substrate 12 is glass having an index of refraction of 1.5, the protective overcoat 74 can have an index of refraction of less than 2, such as 1.3 to 1.8, e.g., 1.5±0.2. The overcoat described above for 74 is useful for monolithic articles.

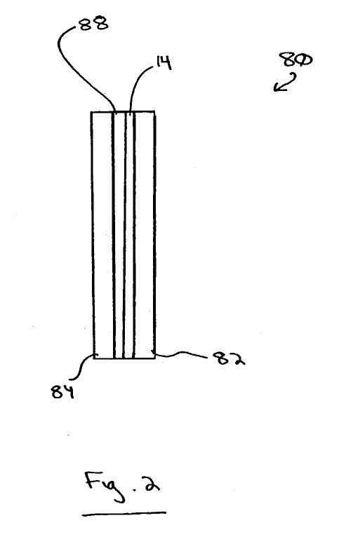

As will be appreciated by one of ordinary skill in the art, the use of a coating 14 of the invention is not limited to monolithic articles as shown in FIG. 1. For example, FIG. 2 shows a laminated article 80 having a first ply 82 and a second ply 84. The first and second plies 82, 84 can be of any desired material, such as those described for the substrate 12 discussed above. Moreover, the first ply 82 can be of a different material and/or of a different transmittance than the second ply 84. The laminated article 80 can be curved.

A coating 14 of the invention is located between the first and second plies 82, 84. For example, the coating 14 can be deposited on a major surface of one of the plies, e.g., the first ply 82.

The first and second plies 82, 84 can be laminated together by an interlayer 88. The interlayer 88 can be of any conventional laminating material, such as plastic materials conventionally utilized in the automotive arts such as for a non-exclusive example poly(vinylbutryal) in either a plasticized or non-plasticized version. In one embodiment, the laminated article 80 can be a laminated automotive transparency, such as a laminated windshield.

The substrate 12 can be heated before, during, or after application of the coating 14. For example, the substrate 12 can be bent or shaped into any desired shape, such as a curved ply, by conventional shaping devices and then the coating 14 applied to one or more major surfaces of the curved substrate 12. After application of the coating 14, the resultant coated article could then be heated or processed, such as for lamination or heat treatment.

In one embodiment of the invention, after application of the coating 14 onto the substrate 12, the resultant coated article can be subjected to a process for increasing the conductivity of the IR reflective films. For example, the coating 14 and/or substrate 12 can be heated to a temperature sufficient to provide a sheet resistance of each IR reflective film in the range of 1.5 to 3.5 ohms/square (Ω/□). For example, the coating 14 can be heated to a temperature greater than or equal to 225° F. (107° C.), e.g., greater than or equal to 250° F. (121° C.), e.g., greater than or equal to 350° F. (176° C.), e.g., greater than or equal to 350° C.

In one embodiment, the coated article 10 having a substrate 12 of clear float glass (2.3 mm thick) with a coating 14 of the invention deposited thereon can have a visible light transmittance (Lta) of greater than or equal to 60%, e.g., greater than or equal to 70%, e.g., greater than or equal to 72%, e.g., greater than or equal to 75%.

The coating 14 has a lower total solar energy reflectance (TSER) than known solar control coatings. For example, the coating 14 can have a TSER of 20% to 50% (using a trapezoidal integration method) over the range of 300 nm to 2150 nm. Moreover, the coating 14 can have a lower visible light reflectance than known solar control coatings. As used herein, the term “visible light reflectance” refers to the reflectance value “Y” using a D65 illuminant. For example, the visible light reflectance of the coating 14 can be less than or equal to 5% above the visible light reflectance of the substrate upon which it is deposited. By “less than or equal to 5% above the visible light reflectance of the substrate” is meant that if the substrate without the coating has a visible light reflectance of 10%, the coated article will have a visible light reflectance of less than or equal to 15%. In one embodiment, the coating 14 can have a visible light reflectance less than or equal to 2%, e.g., less than or equal to 1%, above the substrate without the coating.

In another aspect of the invention, the coating can have a relatively neutral color as defined using conventional CIE color coordinates. By “neutral color” is meant having an a* and b* of less than or equal to ±|3|, such as less than or equal to ±|2|, and an L* of less than or equal to 50, e.g., less than or equal to 44, e.g., less than or equal to 40, e.g., less than or equal to 36, e.g., less than or equal to 35, such as less than or equal to 33. Additionally, the coating 14 can have a low angular color shift. By “low angular color shift” is meant that when the coating is viewed at an angle from perpendicular, the observed color of the coating remains within the neutral color area described above.

The following non-limiting example illustrate the present invention.

A triple infrared reflecting film containing coating was prepared by MSVD sputtering similar to that described for the coating of FIG. 1 where the infrared reflecting films had silver but where the antireflective layers of the the coating were constructed differently. The first, second and third antireflective layers each had a first zinc stannate containing film and a second mixed oxides film of zinc and tin having 90 percent zinc and 10 percent tin as previously described. Of course this order of the films in the antireflective layer could be reversed. Such a coating produced on float glass without a protective film or layer was exposed to indoor ambient conditions for two years without any visible evidence of coating deterioration or change in the neutral color of the coated glass.

The coated glass of the previous example was prepared with a 30 Å thick protective coat of titanium metal through MSVD sputtering and had a total amount in ugm/cm² for all of the films and layers of: Titanium Zinc Silver Tin

| Titanium | Zinc | Silver | Tin |
|---|---|---|---|
| 4.33 | 57.7 | 27.5 | 36.5 |

While some exemplary embodiments and uses of the present invention have been described above, it will be readily appreciated by those skilled in the art that modifications can be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. A coating, comprising:
a first anti-reflective layer;
a first infrared reflective film deposited over the first anti-reflective layer;
a second anti-reflective layer deposited over the first infrared reflective film;
a second infrared reflective film deposited over the second anti-reflective layer;
a third anti-reflective layer deposited over the second infrared reflective film; and
a third infrared reflective film deposited over the third anti-reflective layer.

2. The coating of claim 1, wherein the anti-reflective layers include at least one material selected from the group consisting of metal oxides, oxides of metal alloys, doped metal oxides, nitrides, oxynitrides, and mixtures thereof.

3. The coating of claim 2, wherein the anti-reflective layers include at least one metal oxide selected from the group consisting of oxides of zinc, titanium, hafnium, zirconium, niobium, bismuth, indium, tin, and mixtures thereof.

4. The coating of claim 2, wherein the oxides of metal alloys are selected from the group consisting of zinc stannate and indium-tin alloys.

5. The coating of claim 1, wherein at least one of the anti-reflective layers comprises a plurality of anti-reflective films.

6. The coating of claim 1, wherein the infrared reflective films include a metal selected from the group consisting of gold, copper, silver, aluminum, or mixtures, alloys, or combinations thereof.

7. The coating of claim 1, wherein the first anti-reflective layer has a thickness in the range of 300 Å to 350 Å such as less than 300 Å such as less than 280 Å.

8. The coating of claim 1, wherein the first anti-reflective layer comprises a zinc oxide film deposited over a zinc stannate film.

9. The coating of claim 8, wherein the zinc oxide film has a thickness in the range of 50 Å to 200 Å for example 50 Å to 150 Å.

10. The coating of claim 8, wherein the zinc stannate film has a thickness in the range of 150 Å to 500 Å for example 150 Å to 300 Å.

11. The coating of claim 1, wherein the first infrared reflective film has a thickness in the range of 50 Å to 150 Å.

12. The coating of claim 1, wherein the second anti-reflective layer comprises a first zinc oxide film, a zinc stannate film deposited over the first zinc oxide film, and a second zinc oxide film deposited over the zinc stannate film.

13. The coating of claim 12, wherein the first zinc oxide film has a thickness in the range of 50 Å to 150 Å the zinc stannate film has a thickness in the range of 200 Å to 500 Å and the second zinc oxide film has a thickness in the range of 50 Å to 150 Å.

14. The coating of claim 1, wherein the second infrared reflective film has a thickness in the range of 50 Å to 150 Å.

15. The coating of claim 1, wherein the third anti-reflective layer comprises a first zinc oxide film, a zinc stannate film deposited over the first zinc oxide film, and a second zinc oxide film deposited over the zinc stannate film.

16. The coating of claim 15, wherein the zinc oxide films each have a thickness in the range of 50 Å to 150 Å.

17. The coating of claim 15, wherein the zinc stannate film has a thickness in the range of 200 Å to 500 Å.

18. The coating of claim 1, wherein the third infrared reflective film has a thickness in the range of 50 Å to 100 Å.

19. The coating of claim 1, including a fourth anti-reflective layer deposited over the third infrared reflective film.

20. The coating of claim 19, wherein the fourth anti-reflective layer comprises a zinc stannate film deposited over a zinc oxide film.

21. The coating of claim 20, wherein the zinc stannate film has a thickness in the range of 50 Å to 200 Å.

22. The coating of claim 20, wherein the zinc oxide film has a thickness in the range of 50 Å to 150 Å.

23. The coating of claim 19, including a protective overcoat and/or outer coating deposited over the fourth anti-reflective layer.

24. The coating of claim 23, wherein the protective overcoat and/or outer coating comprises at least one metal oxide selected from the group consisting of titanium oxide, aluminum oxide, silicon oxide, and mixtures thereof.

25. The coating of claim 24, wherein the protective overcoat and/or outer coating has a thickness in the range of 500 Å to 5 microns.

26. A coating, comprising:
a first anti-reflective layer, said first anti-reflective layer comprising a zinc oxide film deposited over a zinc stannate film;
a first infrared reflective metallic film comprising silver and deposited over the first anti-reflective layer;
a second anti-reflective layer deposited over the first infrared reflective film, the second anti-reflective layer comprising a first zinc oxide film, a zinc stannate film deposited over the first zinc oxide film, and a second zinc oxide film deposited over the zinc stannate film;
a second infrared reflective metallic film comprising silver and deposited over the second anti-reflective layer;
a third anti-reflective layer deposited over the second infrared reflective metallic film, the third anti-reflective layer comprising a first zinc oxide film, a zinc stannate film deposited over the first zinc oxide film, and a second zinc oxide film deposited over the zinc stannate film; and
a third infrared reflective metallic film comprising silver and deposited over the third anti-reflective layer.

27. The coating of claim 26, further including a fourth anti-reflective layer deposited over the third infrared reflective metallic film, the fourth anti-reflective layer comprising a zinc oxide film with a zinc stannate film deposited over the zinc oxide film.

28. The coating of claim 26, wherein the first anti-reflective layer comprises zinc stannate having a thickness in the range of 200 Å to 250 Å and zinc oxide having a thickness of 100 Å.

29. The coating of claim 26, wherein the first infrared reflective metallic film has a thickness of about 80 Å.

30. The coating of claim 26, wherein for the second anti-reflective layer, the first zinc oxide film has a thickness of 100 Å the zinc stannate film has a thickness of 400 Å and the second zinc oxide film has a thickness of 100 Å.

31. The coating of claim 26, wherein the second infrared reflective metallic film has a thickness in the range of 80 Å to 90 Å.

32. The coating of claim 26, wherein for the third anti-reflective layer the first zinc oxide film has a thickness of 100 Å the zinc stannate film has a thickness of 400 Å and the second zinc oxide film has a thickness of 100 Å.

33. The coating of claim 26, wherein the third infrared reflective metallic film has a thickness in the range of 75 Å to 85 Å.

34. The coating of claim 27, wherein for the fourth anti-reflective layer the zinc oxide film has a thickness of 100 Å and the zinc stannate film has a thickness in the range of 100 Å to 150 Å.

35. A method of coating a substrate, comprising the steps of:
depositing a first anti-reflective layer over at least a portion of the substrate;
depositing a first infrared reflective film over the first anti-reflective layer;
depositing a second anti-reflective layer over the first infrared reflective film;
depositing a second infrared reflective film over the second anti-reflective layer;
depositing a third anti-reflective layer over the second infrared reflective film; and
depositing a third infrared reflective film over the third anti-reflective layer.

36. A coated article, comprising:
a substrate;
a first anti-reflective layer deposited over at least a portion of the substrate;
a first infrared reflective film deposited over the first anti-reflective layer;
a second anti-reflective layer deposited over the first infrared reflective film;
a second infrared reflective film deposited over the second anti-reflective layer;
a third anti-reflective layer deposited over the second infrared reflective film; and
a third infrared reflective film deposited over the third anti-reflective layer.

37. A coating, comprising:
three spaced infrared reflective films, with at least one anti-reflective layer located between adjacent films.

38. The coating of claim 37, wherein the infrared reflective films include silver.

39. A heatable coated article, comprising:
a substrate; and
a coating comprising three spaced infrared reflective films comprising silver, wherein the coated article has a visible light transmittance of greater than or equal to 60%.

40. A coated article comprising,
a substrate;
a coating comprising three spaced infrared reflective films, wherein the visible light transmittance of the coated article is greater than 72%.

41. A coated article, comprising:
a substrate; and
a coating comprising three spaced infrared reflective films comprising silver, wherein the infrared reflective films have a sheet resistance in the range of 1.5 to 3 ohms per square.

42. A coated article, comprising:
a substrate;
a coating deposited over at least a portion of the substrate and comprising three spaced infrared reflective films, wherein the coated article has a visible light transmittance of greater than or equal to 60%.

43. The coated article of claim 42, wherein the infrared reflective films have a sheet resistance in the range of 1.5 to 3 ohms per square.

44. The coated article of claim 42, wherein the coated article has a color defined by a* and b* less than or equal to ±|3| and an L* less than or equal to 50.

45. The coated article of claim 44, wherein the a* and b* are less than or equal to ±|2|.

46. The coated article of claim 44, wherein the L* is selected from the group consisting of less than or equal to 44, less than or equal to 40, less than or equal to 36, less than or equal to 35, and less than or equal to 33.

47. The coated article of claim 42, wherein the coated article has a TSER in the range of 20% to 50% over the range of 300 nm to 2150 nm.

48. The coated article of claim 42, wherein the coated article has a visible light reflectance of less than or equal to 5% above the visible light reflectance of the substrate.

49. The coated article of claim 48, wherein the coated article has a visible light reflectance of less than 2% above the substrate.

50. The coated article of claim 48, wherein the coated article has a visible light reflectance of less than 1% above the substrate.

51. The coated article of claim 42, wherein the coated article has a Lta of greater than or equal to 72%.

52. The coated article of claim 42, wherein the coated article has a Lta of greater than or equal to 75%.

53. A method of improving the solar control properties of a coating having three or more infrared reflective films, comprising:
heating the coating to a temperature sufficient to obtain a sheet resistance in the range of 1.5 to 3 ohms per square for the infrared reflective films.

54. Coated article of claim 42 which includes:
at least one layer of interlayer material having two opposing major surfaces where one major surface faces the coating on the substrate, and
a second substrate facing the other major surface of the interlayer opposite the surface of the interlayer facing the coated substrate where the coated substrate, interlayer and substrate are in a lamination.

55. Coating of claim 1 wherein the infrared reflecting films have silver and the total amount of silver in all three infrared reflecting films is in the range of 22 to 33 micrograms/centmeter²
